(19) United States
(12) Patent Application Publication
(10) Pub. No.: US 2011/0126949 A1
(43) Pub. Date: Jun. 2, 2011

(54) TIRE TREAD WEAR INDICATOR AND MOLDING DEVICE FOR FORMING A TREAD WEAR INDICATOR

(76) Inventors: André Cuny, Habay La Neuve (BE); Frank Pierre Severens, Arlon (BE)

(21) Appl. No.: 12/629,364

(22) Filed: Dec. 2, 2009

(51) Int. Cl. B60C 11/24; B29C 33/12

(52) U.S. Cl. 152/154.2; 425/173

(57) ABSTRACT

A tire tread for a vehicle tire is disclosed wherein the tread has at least one tread element projecting from the base of the tread and having a defined tread depth, with at least one tread element having a first hole and having a first outer cross-sectional shape that is constant for a first depth. A molding device for forming a tread wear indicator in a tread is also disclosed. The molding device includes a mold blade, the mold blade having a solid first portion having a defined depth, wherein the solid first portion has a cross-sectional shape that is constant for the defined depth.

### FIELD OF THE INVENTION

The present invention is directed to a wear indicator for the tread of a tire and a molding device for forming the wear indicator.

### BACKGROUND OF THE INVENTION

The use of treadwear indicators is not new and the use of treadwear indicators is mandated by law in many countries. A variety of such indicators are known. Once such type employs colored means, such as colored rubber or colored fibers, below the tread for a visual indicator of wear. Other types use tie-bar type elements in the tread grooves, as shown in FIG. 9. The tie bars in the tread grooves can be problematic if they interfere with the water evacuation. When required by law, the upper surface of the tread wear indicator must be located at a height of 1.6 mm from the base of the groove in which the wear indicator is located. Some countries impose additional requirements for a winter tread wear indicator which is located at a height of 4 mm from the base of a groove.

The practical problem with the colored indicators of the type mentioned above is that it is difficult for the operator to determine the level of wear until the tire is worn, since the wear indicator is the same color as the remaining part of the tread.

U.S. Pat. No. 6,523,586 discloses wear indicators for a tire tread wherein, in a series, or predetermined closely located grouping, of related marks, the marks disappear as the tire is worn. While this provides continuous information to the consumer, the complexity of forming the tire is increased due to the need to form multiple different marks that appear only after a defined amount of wear.

### SUMMARY OF THE INVENTION

The present invention is directed to a tire comprising at least one tread wear indicator. Also disclosed is a mold blade used to form the tread wear indicator. The blade has a first portion having first a cross-sectional shape which stays constant for a defined depth of the blade. The blade may further optionally comprise a second portion having a second cross-sectional shape which remains constant for a second defined depth of the blade. The blade may further optionally comprise a third portion having a third cross-sectional shape for a third defined depth of the blade.

Disclosed is a tire tread for a vehicle tire, the tread having at least one tread element projecting from the base of the tread and having a defined tread depth. At least one of the tread elements has a tread wear indicator. The wear indicator is a hole formed in the tire having a constant cross-sectional shape for a defined tread depth d. Thus for example, the wear indicator could be a snowflake hole that disappears after the defined depth has been worn away. The wear indicator could also include a second hole in the tread having a shape which appears after the first cross-sectional shape wears away. The second shape would have a different cross-sectional shape than said first shape, and have a constant cross-sectional shape for a defined depth. The wear indicator may further optionally include a third hole having a different cross-sectional shape than said first or second hole.

### Definitions

The following definitions are applicable to the present invention.

“Inner” means toward the inside of the tire and “outer” means toward its exterior.

“Outer” means toward the tire's exterior.

“Radial” and “radially” are used to mean directions radially toward or away from the axis of rotation of the tire.

“Tread” means a molded rubber component which, when bonded to a tire casing, includes that portion of the tire that comes into contact with the road when the tire is normally inflated and under normal load. The tread has a depth conventionally measured from the tread surface to the bottom of the deepest groove of the tire.

### BRIEF DESCRIPTION OF THE DRAWINGS

The invention will be described by way of example and with reference to the accompanying drawings in which:

FIG. 1 is a perspective view of a portion of a tire tread, wherein the left side of the tire is new or unworn, and the right hand side of the tire has been worn slightly more than 4 mm;

FIG. 2 illustrates a design of a tread wear indicator;

FIG. 3 is a cross sectional view of a portion of a tread molding segment and a tread wear indicator molding device;

FIG. 4 is a side view of a molding device;

FIG. 5 is a top view of a molding device of FIG. 4;

FIG. 6 is a perspective view of the molding device;

FIG. 7 is a perspective view of a second embodiment of a blade of the molding device;

FIG. 8 is a cross-sectional view of a tire tread illustrating a tread wear indicator of the present invention;

FIG. 9 is a cross-sectional view of a tire tread illustrating prior art tread indicators;

FIG. 10 is an exploded view of a second embodiment of a molding blade for a tire tread indicator;

FIG. 11 is a top view of the molding blade of FIG. 10;

FIG. 12 illustrates the two tread wear indicator shapes of the blade of FIG. 10;

FIG. 13 is a side view of a third embodiment of a molding blade installed in a portion of a tread segment;

FIG. 14 is a top view of the blade of FIG. 13 in the direction 14-14;

FIG. 15 is a top view of the blade of FIG. 13;

FIG. 16 illustrates the three possible tread wear indicator shapes for the blade of FIG. 13.

FIG. 17 illustrates the tread having the tread wear indicators of FIG. 13.

### DETAILED DESCRIPTION OF THE INVENTION

The following language is of the best presently contemplated mode or modes of carrying out the invention. This description is made for the purpose of illustrating the general principles of the invention and should not be taken in a limiting sense. The scope of the invention is best determined by reference to the appended claims. The reference numerals as depicted in the drawings are the same as those referred to in the specification. For purposes of this application, the various embodiments illustrated in the figures each use the same reference numeral for similar components. The structures employed basically the same components with variations in location or quantity thereby giving rise to the alternative constructions in which the inventive concept can be practiced.

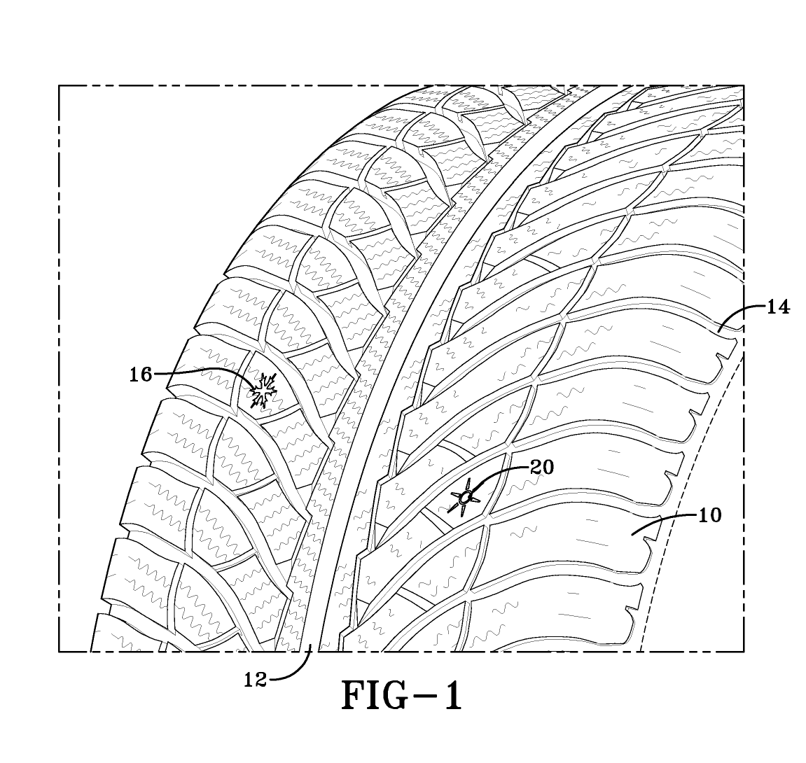

FIG. 1 illustrates a portion of a tire tread. The tread may comprise a plurality of blocks 10 defined by circumferential and lateral grooves 12, 14. The left hand side of the tire tread is shown in the unworn state, or new condition and illustrates a snowflake shaped hole or tread wear indicator 16. The right hand side of the tire is shown with slightly more than 4 mm of wear. The exact configuration of the tread is irrelevant to the present invention and any tread configuration may be employed. Located in the tread is one or more wear indicators 20. The wear indicator 20 may be located in any desired location such as a tread block, rib or anywhere else on the outer tread surface. The wear indicator cannot be located in a groove or channel.

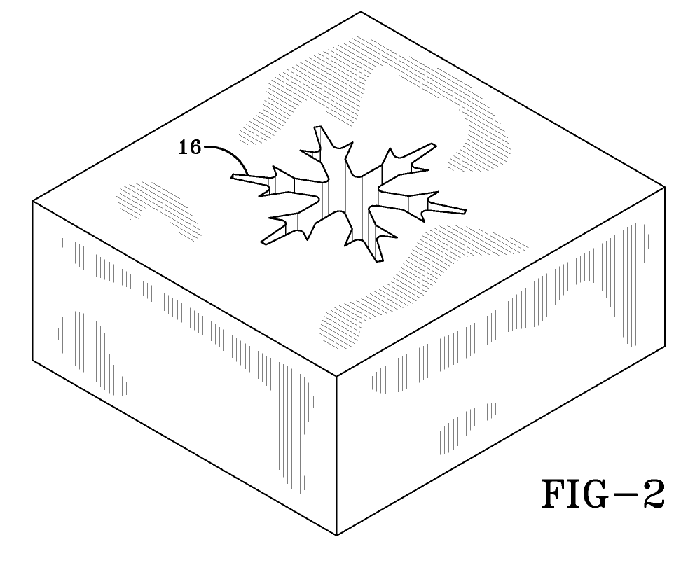

When unworn, the wear indicator 20 is represented by a hole or cutout in the tread surface having a first shape. As shown in FIG. 2, the outer perimeter of the cutout configuration is shaped like a snowflake 16, but may be any other desired shape. A snowflake shaped hole 16 will appear on the outer surface of the tire until a defined tread depth has been worn away. Thus for example, if the snowflake hole has a depth of 4 mm, the snowflake will disappear when the tread has eroded 4 mm. The disappearance of the first shape alerts the consumer that the tire has worn to a predetermined level. The configuration may be any type of configuration that readily communicates this to the consumer. The depth of the cutout may be selected by the tire designer to be applicable to different government standards.

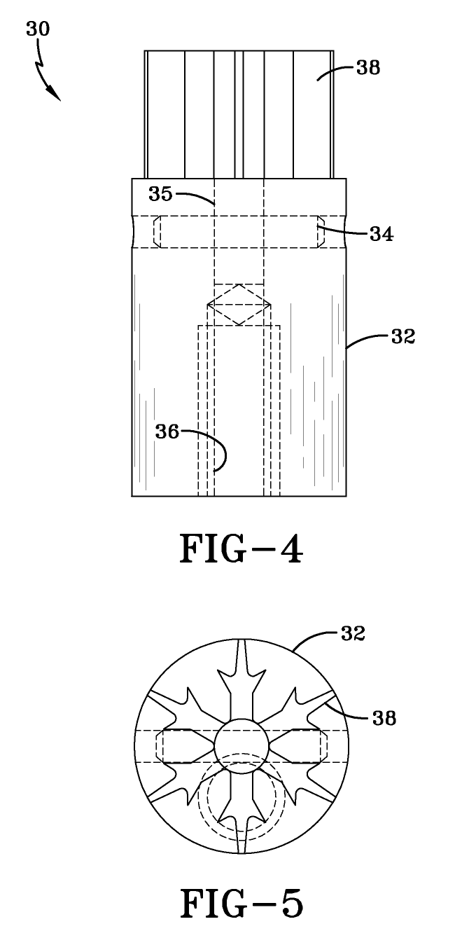

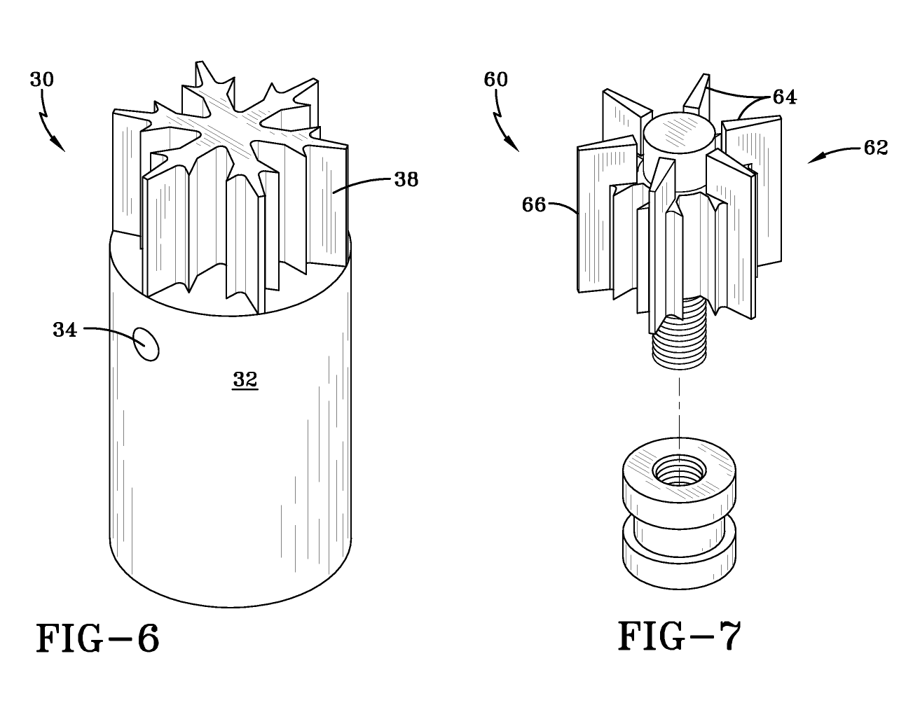

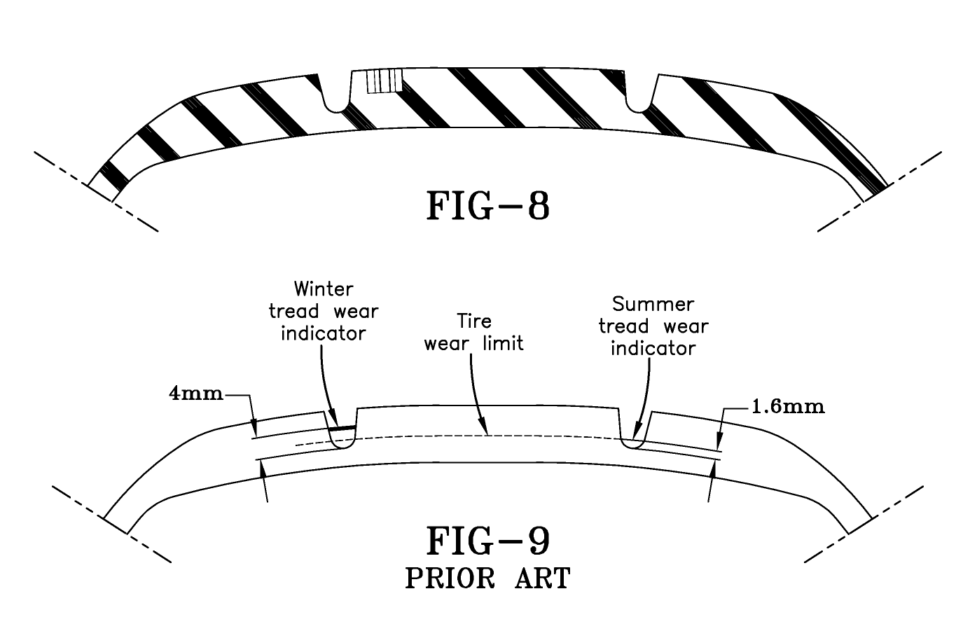

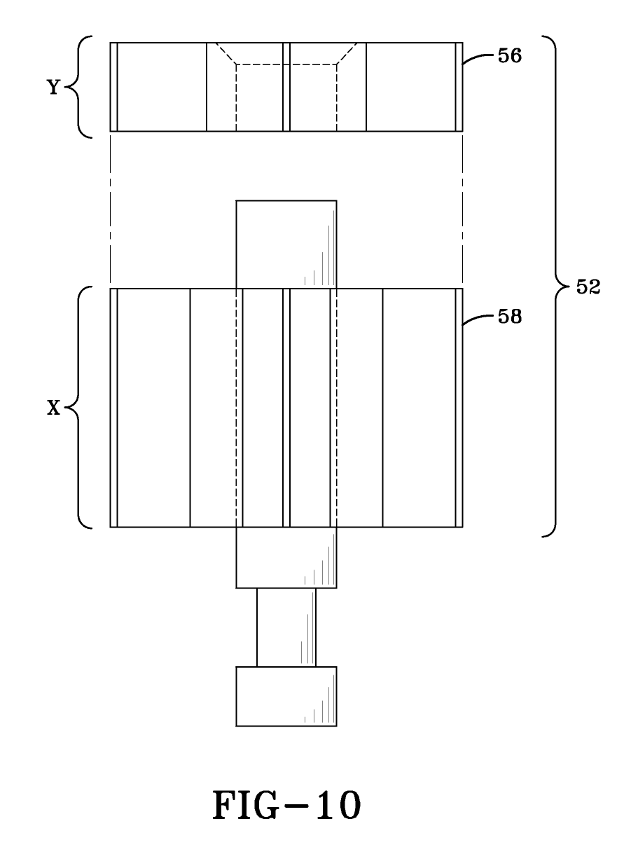

A first molding device 30 of the present invention is shown in FIGS. 4-6. The molding device has a base 32 having an internal pin 34 and an internal bore 36 for receiving a screw or other fastener to a mold segment. The base 32 further comprises a blade 38. The blade has a male portion 35 that is received in the bore of base 32 and secured to the base 32 via pin 34. The blade is shaped in this example as a snowflake, although other designs would work for the invention. The depth of the blade is sized as desired. The molding device 30 is formed from conventional mold materials, such as steel, aluminum, or pressed metal.

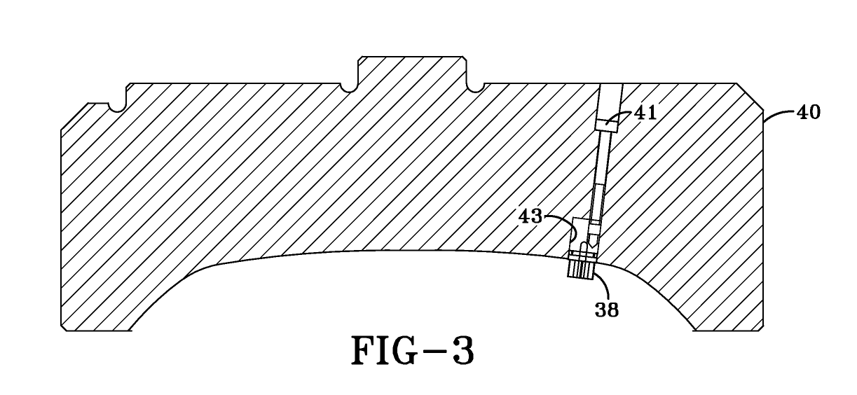

FIG. 3 illustrates the molding device 32 inserted in a segment 40. It is important to note that the full depth of the blade 38 extends into the mold. The molding device 32 is secured in a hole 43 of the tread segment via a fastener 41 which is secured to bore 36.

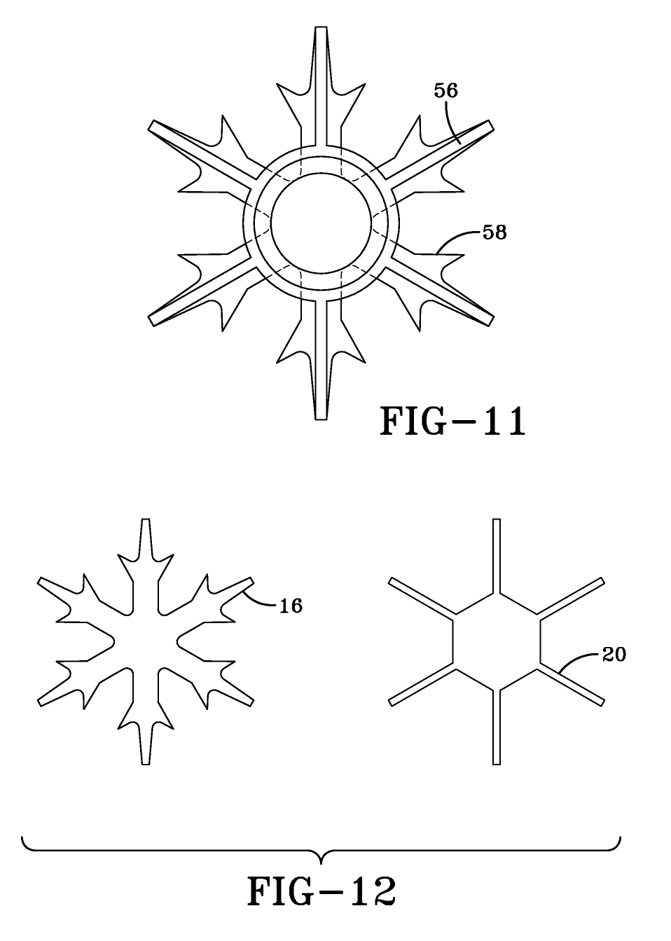

A second embodiment of a molding blade 52 is shown in FIGS. 10-12. The blade 52 has an outer portion 56 having a first shape, which in this case is shaped like a sun indicia 20. The blade 52 has an inner portion 58 formed of a second shape, which in this case is a snowflake indicia 16. Thus when molded in a tire, the consumer will first see a snowflake hole 16 shaped as in FIG. 12 for a depth X which corresponds to the blade 58 depth, and will then see a second symbol 56 in the shape of a sun indicia 20 for a depth y which corresponds to the depth of the blade 56. Preferably, the first and second holes are aligned.

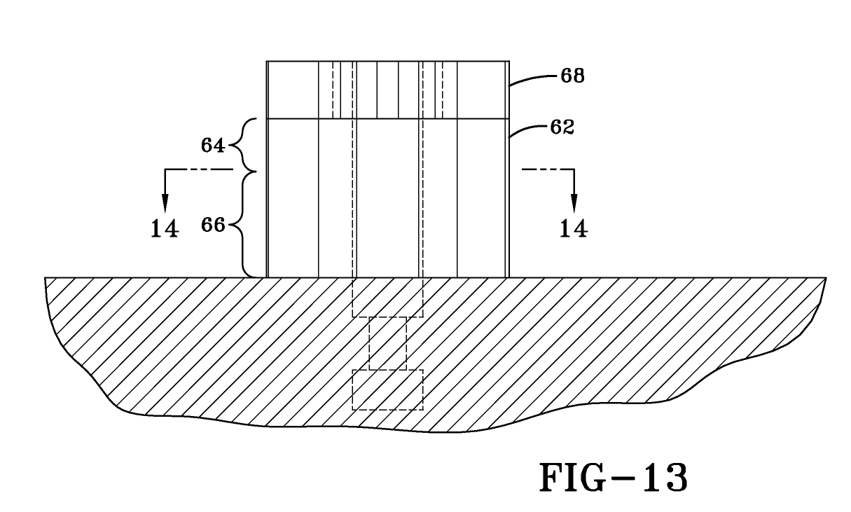

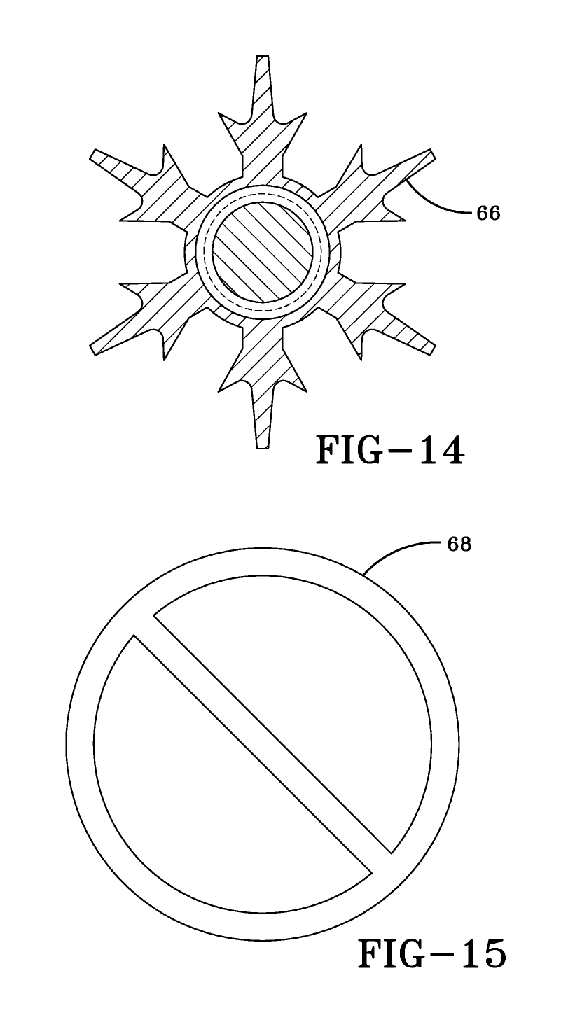

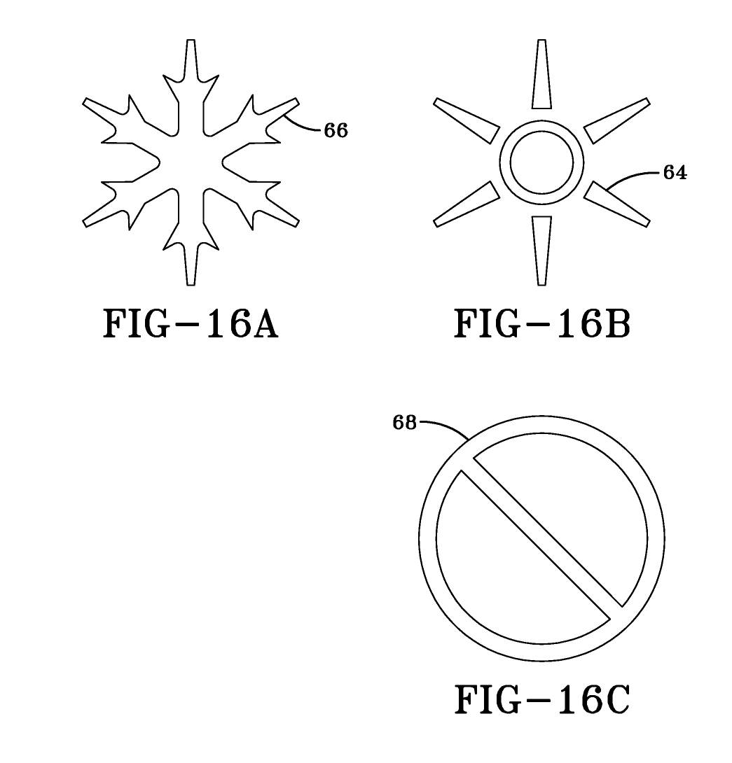

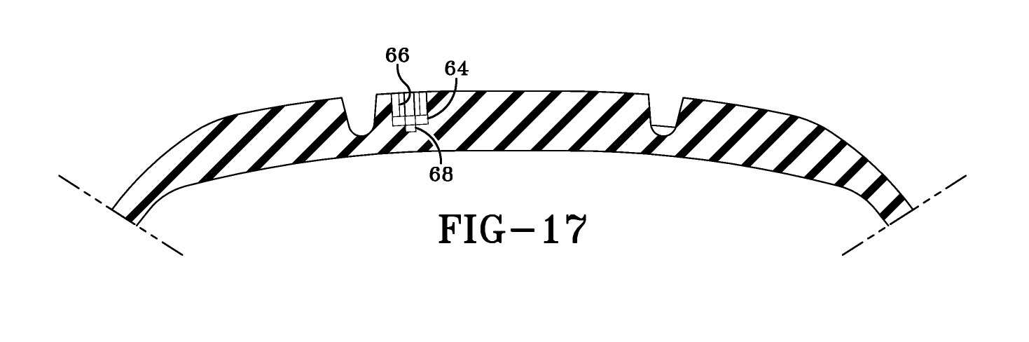

FIG. 7 and FIGS. 13-16 illustrate a third embodiment of the invention. The blade 62 has an outer portion having a first shape in a sun indicia 64, and an inner portion having a second shape of a snowflake indicia 66. An optional third portion 68 has a third symbol, and in this case is a forbidden symbol (circle with a slash). As shown in FIG. 16A-C, the consumer will first see a snowflake indicia 66 (FIG. 16A) on the outer surface of the tread for a specified depth, then a first sun indicia 64 for a second specified depth (FIG. 16B), and then finally a warning indicia 68 (FIG. 16C). The warning indicia hole will remain on the face of the tire tread from a first warning depth (e.g., 1.8 mm) until the nonskid depth.

FIG. 17 illustrates a cross-sectional view of a tread shown with a snowflake shaped tread wear indicator 66. The snowflake indicator is visible on a new tread and has a depth of 4 mm. After the tread has been worn to a depth of 4 mm, the sun tread wear indicator 64 will be displayed until a tread depth of 1.6 mm. A warning indicia will then be displayed from 1.6 mm until groove depth is reached.

Variations in the present inventions are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A tire tread for a vehicle tire, the tread having at least one tread element projecting from the base of the tread and having a defined tread depth, at least one tread element having a first hole and having a first outer cross-sectional shape that is constant for a first depth.

2. The tread of claim 1 wherein said first hole has a second cross-sectional shape that is constant for a second depth.

3. The tread of claim 1 wherein the first cross-sectional shape is a snowflake indicia.

4. The tread of claim 1 wherein the second cross-sectional shape is a sun indicia.

5. The tread of claim 1 wherein the wear indicator is a hole having three different defined depths, and each depth having a constant cross-sectional shape, wherein each shape is a different indicia.

6. A molding device for forming a tread wear indicator in a tread, the molding device comprising a mold blade, the mold blade having a solid first portion having a defined depth, wherein the solid first portion has a cross-sectional shape that is constant for the defined depth.

7. The molding device of claim 6 wherein the mold blade has a second solid portion having a second defined depth, wherein the second portion has a constant cross-sectional shape for a second defined depth.

8. The molding device of claim 6 wherein the first portion of the mold blade has a cross-sectional shape of a snowflake.

9. The molding device of claim 6 wherein the second portion of the mold blade has a cross-sectional shape of a sun indicia.
